(19) United States
(12) Patent Application Publication
(10) Pub. No.: US 2021/0045383 A1
(43) Pub. Date: Feb. 18, 2021

(54) ORGANIC METABOLITE COMPOSITIONS AND METHODS OF USE AS MITICIDES FOR HONEY BEES

(71) Applicant: Paul Niemczura, Malvern, PA (US)

(72) Inventor: Paul Niemczura, Malvern, PA (US)

(21) Appl. No.: 16/980,385

(22) PCT Filed: Mar. 12, 2019
(86) PCT No.: PCT/US2019/021916

§ 371 Date: Sep. 12, 2020

Related U.S. Application Data
(60) Provisional application No. 62/641,875, filed on Mar. 12, 2018.

(51) Int. Cl. A01N 37/02; A01N 25/34

(52) U.S. Cl. CPC A01N 37/02; A01N 25/34

(57) ABSTRACT

A miticide treatment strip and methods of use for controlling Varroa destructor parasitic mites in honey bee colonies using acidic compounds containing organic metabolites or mixtures thereof as miticidal agents. Miticidal agents are introduced into beehives in solid or crystalline solid form by way of hanging treatment strips coated with the miticidal agent. Use of organic metabolites eliminates mite resistance, honey contamination, bee mortality, and other common drawbacks of current mite management treatments, and can be used without regard to ambient air temperature, brood, and nectar cycle limitations.

### CROSS-REFERENCE TO RELATED APPLICATIONS

Reference is made to and priority claimed from U.S. Provisional Application No. 62/641,875, filed on Mar. 12, 2018, the disclosure of which is herein incorporated by reference in its entirety.

### BACKGROUND

The present disclosure pertains to the field of animal husbandry, specifically reducing mite-related bee mortality using miticides based on organic metabolites.

Honey bees (Apis Mellifera) have become globally infested with an external parasitic mite, Varroa destructor, for over the past 30 years. This mite feeds on both adult and larval bees, weakening adults by causing wounds between abdominal plates and vectoring a host of viruses, and harming the larvae upon whom the mites lay eggs and thus feed upon during development, leading to stunted and weakened adult bees. Deformed Wing, for instance, is a devastating viral disease spread by mites, resulting in shortened abdomens, deformed wings and smaller bees often seen port-mortem when examining dead hives. The parasitic behavior of Varroa destructor in honey bee colonies has been directly linked to premature die off in a large percentage of colony losses documented over the past few decades and is believed to be a significant cause of Colony Collapse Disorder (CCD) devastating apiculture worldwide. In parts of the United States, losses attributed to Varroa and other mites have been upwards of 75% in a given year, a devastating economic blow to commercial and backyard beekeepers alike.

Varroa management is now a major task for the beekeeper, and while there are still some beekeepers who forgo all Varroa management, standard Varroa management practices recommend a minimum of two annual mite treatments per hive, and treatments selected based on brood cycles, nectar flow, and ambient air temperatures.

What is needed is a convenient, effective, and economical miticide for Varroa destructor management with less restrictive treatment and temperature windows, with low bee mortality, and no harmful effects of hive products or human health.

### SUMMARY OF THE INVENTION

What is presented is a miticide treatment strip for controlling honey bee parasites. The miticide treatment strip comprises a treatment strip having a surface, a base coating of at least one of a thermoplastic wax, resin, and polymer on the surface, and an acidic compound having an active ingredient applied to the base coating. The active ingredient is at least one of an amino acid and a vitamin and the acidic compound is a solid. The treatment strip is a substrate further comprised of at least one of plastic, paper, cardboard, mylar, metal, and thermoplastic.

The active ingredient could be at least one of (S)-2-Amino-5-guanidinopentanoic acid), (2-Amino-3-(1H-imidazol-4-yl)propanoic acid,(2S,3S)-2-amino-3-methylpentanoic acid), 2-Amino-4-methylpentanoic acid, 2,6-Diaminohexanoic acid, 2-amino-4-(methylthio)butanoic acid, (S)-2-Amino-3-phenylpropanoic acid, (2-Amino-3-hydroxybutanoic acid), (2-Amino-3-(1H-indol-3-yl)propanoic acid, 2-Amino-3-methylbutanoic acid, aminoethanoic acid, 2-Aminopropanoic acid, L-2-Amino-3-(4-hydroxyphenyl)propanoic acid, 2-Amino-3-hydroxypropanoic acid, 2-Amino-3-sulfhydrylpropanoic acid, aminobutanedioic acid, 2-aminoglutaric acid, 2-amino-3-carbamoylpropanoic acid, 2-amino-4-carbamoylbutanoic acid, pyrrolidine-2-carboxylic acid, pyridine-3-carboxylic acid, (5R)-[(1S)-1,2-Dihydroxyethyl]-3,4-dihydroxyfuran-2(5H)-one ascorbic acid, (2S)-2-[[4-[(2-amino-4-oxo-3H-pteridin-6-yl)methylamino]benzoyl]amino]pentanedioic acid, and 5-[(3as,4S,6ar)-2-oxohexahydro-1H-thieno[3,4-d]imidazol-4-yl]pentanoic acid.

In some embodiments the active ingredient could be a crystalline solid, or selected from the group consisting of aspartic acid, arginine, cysteine, glutamic acid, histidine, and niacin.

In some embodiments, the miticide treatment strip has a thickness of no more than 1.5 mm and is at least one of stock cardboard and corrugated cardboard. In some embodiments, the treatment strip is corrugated cardboard no more than 2 mm thick.

The base coating may be between 0.2 and 0.4 mm thick. In some embodiments, the base coating may be at least one of beeswax, paraffin wax, microcrystalline wax, oxidized polyethelene, unoxidized polyethelene, and polypropylene. In some embodiments, the base coating is at least one of hydrocarbon rosin, modified resin, unmodified resin, and derivatives thereof.

The surface holds about 1 g to 5 g of the acidic compound. The active ingredient may be adhered to the base coating with an adhesion promoter that is at least one of a film of solvent, tackifying resin, and a plasticizer.

A pest control method for honey bee parasitic mites using a miticide treatment strip within a beehive is also presented. In this method, the beehive is comprised of a hive body housing at least two frames positioned to have a bee spacing, and a plurality of bees on the frames. The method comprises increasing the bee spacing between the at least two frames and hanging the miticide treatment strip vertically between the at least two frames spaced so as to allow the plurality of bees sufficient room to pass over and under all sides of the treatment strip with a passage space between the miticidal strip and the frame measuring less than the bee spacing. On the first day of a treatment period, the treatment strip is hung between the frames. The treatment strip is inspected after 10 to 14 days removed from the hive. In this method, the miticide treatment strip comprises a substrate coated with a solid acidic compound having as an active ingredient an organic metabolite comprised of at least one of an amino acid and a vitamin. The plurality of bees further comprises at least one of a quantity of adult bees, a quantity of capped brood, and a quantity of uncapped brood.

In some embodiments of this method, prior to the step of hanging, first determining whether the quantity of uncapped brood is present in at least one frame and positioning the treatment strip immediately adjacent the uncapped brood.

In some embodiments, after the step of removing, assessing whether capped brood is present in the hive, replacing the treatment strip with a fresh treatment strip; and removing the fresh treatment strip no earlier than 14 days after the first day of the treatment period. These steps are repeated until mite levels are reduced to an acceptable level of less than 2 mites per 100 bees. In some embodiments of the method one treatment strip is used per four to five frames of uncapped brood.

In each of these methods the active ingredient could be at least one of (S)-2-Amino-5-guanidinopentanoic acid), (2-Amino-3-(1H-imidazol-4-yl)propanoic acid,(2S,3S)-2-amino-3-methylpentanoic acid), 2-Amino-4-methylpentanoic acid, 2,6-Diaminohexanoic acid, 2-amino-4-(methylthio)butanoic acid, (S)-2-Amino-3-phenylpropanoic acid, (2-Amino-3-hydroxybutanoic acid), (2-Amino-3-(1H-indol-3-yl)propanoic acid, 2-Amino-3-methylbutanoic acid, aminoethanoic acid, 2-Aminopropanoic acid, L-2-Amino-3-(4-hydroxyphenyl)propanoic acid, 2-Amino-3-hydroxypropanoic acid, 2-Amino-3-sulfhydrylpropanoic acid, aminobutanedioic acid, 2-aminopentanedioic acid, 2-amino-3-carbamoylpropanoic acid, 2-amino-4-carbamoylbutanoic acid, pyrrolidine-2-carboxylic acid, pyridine-3-carboxylic acid, (5R)-[(1S)-1,2-Dihydroxyethyl]-3,4-dihydroxyfuran-2(5H)-one, (2S)-2-[[4-[(2-amino-4-oxo-3H-pteridin-6-yl)methylamino]benzoyl]amino]pentanedioic acid, and 5-[(3as,4S,6ar)-2-oxohexahydro-1H-thieno[3,4-d]imidazol-4-yl]pentanoic acid. In other embodiments of the method the active ingredient is selected from the group consisting of aminobutanedioic acid, (S)-2-Amino-5-guanidinopentanoic acid), 2-Amino-3-sulfhydrylpropanoic acid, 2-aminopentanedioic acid, (2-Amino-3-(1H-imidazol-4-yl)propanoic acid, and pyrrolidine-2-carboxylic acid.

A miticide solution for controlling honey bee parasites is also presented. The solution comprises an aqueous-sucrose solution in a 1:1 ratio into which a predetermined quantity of an acidic compound having an active ingredient is mixed such that a concentration of active ingredient in the miticide solution is about 3.5 to 5.5%. The active ingredient is at least one of (S)-2-Amino-5-guanidinopentanoic acid), (2-Amino-3-(1H-imidazol-4-yl) propanoic acid,(2S,3S)-2-amino-3-methylpentanoic acid), 2-Amino-4-methylpentanoic acid, 2,6-Diaminohexanoic acid, 2-amino-4-(methylthio) butanoic acid, (S)-2-Amino-3-phenylpropanoic acid, (2-Amino-3-hydroxybutanoic acid), (2-Amino-3-(1H-indol-3-yl) propanoic acid, 2-Amino-3-methylbutanoic acid, aminoethanoic acid, 2-Aminopropanoic acid, L-2-Amino-3-(4-hydroxyphenyl) propanoic acid, 2-Amino-3-hydroxypropanoic acid, 2-Amino-3-sulfhydrylpropanoic acid, aminobutanedioic acid, 2-amino pentanedioic acid, 2-amino-3-carbamoylpropanoic acid, 2-amino-4-carbamoylbutanoic acid, pyrrolidine-2-carboxylic acid, pyridine-3-carboxylic acid, (5R)-[(1S)-1,2-Dihydroxyethyl]-3,4-dihydroxyfuran-2(5H)-one, (2S)-2-[[4-[(2-amino-4-oxo-3H-pteridin-6-yl)methylamino]benzoyl]amino]pentanedioic acid, and 5-[(3as,4S,6ar)-2-oxohexahydro-1H-thieno[3,4-d]imidazol-4-yl]pentanoic acid.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### DETAILED DESCRIPTION

This disclosure describes a miticide treatment and methods of use, the treatment comprises the use of a miticide treatment strip or strips that are coated or impregnated with a compound having as its active ingredient one or more organic metabolites used to kill Varroa destructor, Acarapis woodi, and other mites that commonly attack honey bees. References to Varroa or mites generally in this disclosure include all common mites known to attack honey bees and is not meant to limit the compounds and methods of treatment specifically to Varroa. The compounds described herein are acidic in nature or contain a carboxylic acid moiety in its chemical structure. Specifically, the compounds include as their active ingredient amino acids, vitamins, or various combinations thereof, and that are organic metabolites occurring in either animals or microbes. The method of application and concentrations in which these compounds are introduced into a bee colony as miticides, as described in this disclosure, are novel and not currently known in the prior art.

For use as a miticide, the acidic compounds include one or more of the following organic metabolites as active ingredients: (S)-2-Amino-5-guanidinopentanoic acid, 2-Amino-3-(1H-imidazol-4-yl)propanoic acid, (2S,3S)-2-amino-3-methylpentanoic acid, 2-Amino-4-methylpentanoic acid, 2,6-Diaminohexanoic acid, 2-amino-4-(methylthio)butanoic acid, (S)-2-Amino-3-phenylpropanoic acid, 2-Amino-3-hydroxybutanoic acid, 2-Amino-3-(1H-indol-3-yl)propanoic acid, 2-Amino-3-methylbutanoic acid, Aminoethanoic acid, 2-Aminopropanoic acid, L-2-Amino-3-(4-hydroxyphenyl)propanoic acid, 2-Amino-3-hydroxypropanoic acid, 2-Amino-3-sulfhydrylpropanoic acid, Aminobutanedioic acid, 2-Aminoglutaric acid, 2-Amino-3-carbamoylpropanoic acid, 2-Amino-4-carbamoylbutanoic acid, Pyrrolidine-2-carboxylic acid, Pyridine-3-carboxylic acid, (5R)-[(1S)-1,2-Dihydroxyethyl]-3,4-dihydroxyfuran-2(5H)-one, (2S)-2-[[4-[(2-amino-4-oxo-3H-pteridin-6-yl)methylamino]benzoyl]amino]pentanedioic acid, 5-[(3as,4S,6ar)-2-oxohexahydro-1H-thieno[3,4-d]imidazol-4-yl]pentanoic acid.

The list of active ingredients in this disclosure are in fact naturally occurring compounds in honey, hive products, or bees themselves, and enter a hive by way of foraging honey bees returning to the hive, and as the active ingredients originate in nectar, pollen or both, the concentration and distribution of any active ingredient in the hive varies by plant species foraged. The active ingredients are also present in the bee itself and are possibly introduced via microorganisms in the bee gut, in varying amounts, and are thus not naturally present in the concentrations and distributions disclosed herein for miticidal use.

Miticidal compounds comprising one or more of the active ingredients disclosed herein can be introduced to honey bees or honey bee colonies as either solids or liquids using modified prior art miticidal delivery methods.

A method of using the miticidal compounds using a Dribble Method is as follows: A liquid solution is prepared by choosing a desired compound as previously described and formulating a liquid solution where between 3.5 to 5.5% of the active ingredient is dissolved in a 50/50 water/sucrose mixture. The concentration of the compound varies based on the pKa and total acidity per gram of the compound. The resulting liquid solution is applied at a rate of 5 ml per “seam” of bees via a syringe. Here, a “seam” of bees are those visible bees in the bee space between two immediately adjacent frames in a cluster of bees inside the hive body in late fall or early winter. As the liquid miticide cannot penetrate capped brood, it must be performed while the colony is broodless and before ambient temperatures are much lower than 50° Fahrenheit to prevent introducing extra moisture to the hive. Due to time and temperature limitations with this method, as well as the possible deleterious effect of washing the bees in an acidic solution, the dribble method using a liquid solution is not an optimal yet still useful treatment option.

Use of the miticidal compound in a solid or a crystalline solid form is achieved by mechanically coating or impregnating at least one surface of a thin substrate in the form of a treatment strip or strips with the compound containing at least one or more of the active ingredients listed. The strip can be made in a variety of predetermined dimensions, depending on the substrate used and the desired dosage per strip. Suitable substrates include stock cardboard having a width dimension of between 0.5 to 1.5 mm thick, corrugated cardboard having a width dimension between 1 to 2 mm thick, and a plurality of plastics such as polyethylene terephthalate, polyethylene, and poly propylene having a width dimension of between 0.08 to 0.12 mm thick. A typical strip size ranges between 19.05 to 50.8 mm wide, and 101.6 to 203.2 mm long, however, the overall strip size is ultimately dependent on desired treatment dosage. The strip is coated with a base or adhesive coating of wax, resin, or a polymer of mixtures thereof further softened or tackified using heat or a solution of tackifying agents applied as a thin film of between 0.2 to 0.4 mm thick by dipping or flow coating to the base or adhesive coating on the surface of the strip. Useful base coatings or adhesive coatings include beeswax, paraffin, microcrystalline wax, oxidized and unoxidized polyethylene, polypropylene, hydrocarbon rosins, or resin modified or unmodified or their derivatives, ethylene-vinyl acetate (EVA), polyolefins, polyamides, and polyesters, styrene block copolymers, polyethylene and ethylene-methyl acrylate (EMA), and ethylene n-butyl acrylate (ENBA). The surfaces of the strip are then typically coated with between 1 and 5 g of the miticidal compound. It should be noted that the surface may be evenly or unevenly coated, and the coating on one side of the strip may contain a same or a different active ingredient as compared to the coating on another side of the strip. A concentration of active ingredient used will vary depending on the pKa and total acidity per gram of compound with an optimal concentration being between 1.5 and 2.5 g especially of the most acidic compounds on the list, specifically aminobutanedioic acid, (S)-2-Amino-5-guanidinopentanoic acid), 2-Amino-3-sulfhydrylpropanoic acid, 2-aminopentanedioic acid, (2-Amino-3-(1H-imidazol-4-yl)propanoic acid, and pyrrolidine-2-carboxylic acid, with an optimal pKa¹ of 2.8 or lower. The pKa1 range of the suitable amino acids is from 1.7 to 2.6, with pyrrolidine-2-carboxylic acid at 2.79. In comparison, the rest of the vitamins suitable for use as miticides have a pKa¹ range between 4.2 to 4.4. Each strip is hung or suspended between drawn frames with a small hook or other suitable attachment method.

Optimally, placement of the strip is between frames of uncapped brood, or areas where bees are actively being raised. One strip is used per four to five frames of brood frames present in the colony, and remains in place for an initial treatment period of 10 to 14 days, after which the beekeeper can reassess and continue treatment by replacing with fresh strips for a subsequent treatment period to push the treatment beyond a 21 day brood cycle period to ensure that mites under the broodcap are exposed to the miticidal compound. At a start of a treatment period, if there is no brood, or when there is no capped brood present, the initial treatment period is often sufficient to reduce Varroa populations to an acceptable level. However, the treatment may be repeated until acceptable mite levels are present in the hive.

For most effective mite control, increasing bee space between the frames beyond normal bee spacing is recommended to allow the bees to easily pass over and around both sides of the strip during treatment. Normal bee spacing or bee space is understood as a regular space existing between two immediately adjacent frames, or between an outermost frame and an innermost wall of a hive body. Typically, in a hive body consisting of a set of eight or ten frames, the frames are immediately adjacent one another and the set of frames are then centered within the hive body. Hence, normal bee space is often slightly larger between the outermost frames and the inner walls of the hive body as compared to the bee space between immediately adjacent frames. Hence, when a single strip is used, the bee space between the frames are adjusted outwards towards the inner walls of the hive body. If two strips are required in a hive body during treatment, it is preferred that a broodless frame is removed temporarily to allow extra spacing between the frames where the strips are placed.

The compounds disclosed herein have proven to be most effective when introduced into honey bee colonies in a solid or crystalline solid form as per the strip method described herein. Introduction into the hive as a solid or crystalline solid is an effective miticide for use at any time of year regardless of weather conditions and stages of colony development or honey production. Even a broodless hive can benefit from the methods and compounds described herein. Additionally, optimal delivery in solid or crystalline solid form isolated to larval development or brood nesting areas of the colony virtually eliminates the introduction of these compounds into the honey inside the hive. However, even if minute amounts of these compounds are transferred or transported into honey or ripening nectar, there are no deleterious effects to the bees or to humans, since all these compounds are already approved for use as nutritional supplements and hence deemed safe.

Testing of the miticidal treatment strips and the method of use described herein was conducted as follows: In a series of test hives, one treatment interval or treatment period consisted of positioning two treatment strips representing a miticide dosage of 2.5 to 4 g in a brood area or near a queen bee in the case of a broodless hive, sufficiently spaced so as to allow bees to pass over all surfaces of the treatment strips for two weeks. Additional treatment periods were performed by removing old strips and replacing them with fresh strips. Treatment efficacy was determined in two ways: (1) by comparing mite drops on sticky boards positioned on the bottom board prior to and during the treatment period; and (2) by counting mites using a sugar roll method prior to and after the treatment period. Both methods showed the miticide treatment strips reduced mite infestations. As a test starting point during spring and summer months, mite treatments were suspended to allow mite levels to reach a high or critical level, measured as 5 to 10 mites per 100 bees using the sugar roll method. Mite levels were then calculated using the sugar roll method at an end of each treatment period. Mite levels in a series of control hives (non-treated hives) were also monitored using the same methods, and from the same starting mite levels of 5-10 mites per 100 bees.

In the series of test hives, after one treatment period, mite levels were measured to be at a high level, approximately 5 mites/100 bees. When treatments continued for an additional 2 or 3 treatment periods (for a total of 4 to 6 weeks), mite levels were diminished to an acceptable level of less than 2 mites per 100 bees. In the series of control hives, in contrast, by the end of 3 to 4 weeks (approximately 1.5 to 2 treatment periods) had mite populations exceeding 50 mites per 100 bees. There was no measurable bee toxicity or other deleterious effects in the hives, and since the active ingredient was administered as a solid, treatment efficacy was unaffected by humidity, ambient air temperature, length of treatment, brood presence, nectar flow, and presence or absence of honey supers on the hives.

Testing was also conducted using glutamic acid and aspartic acid, using single treatments on a three-month schedule, resulting in consistent mites loads of zero in the treated hives. A mid-summer treatment was skipped, resulting in mite counts above 3 per 100 bees in early fall (September), and once resumed, reduced mite loads to an acceptable level.

The miticide treatment strip and method of use described herein thus have many advantages over prior art treatments and methods. Standard apiculture recommendations for Varroa management to perform at least two annual mite treatments, once during early spring when the hive is broodless, and once again in summer to knock down mite populations. Many beekeepers do at least three treatments annually, including a fall treatment to control overwintering mites whose unchecked populations is often the cause of hive death in late winter or early spring. Currently, there are synthetic, organic, and “natural” treatments and methods of controlling Varroa but each have their limitations, and mite resistance and pesticide contamination concerns are so pervasive that beekeepers are urged to use alternating methods and treatments during the year to minimize the negative effects of these treatments and methods.

Synthetic miticides, such as Apivar™ (amitraz), Apistan™ (tau-fluvalinate), and checkmite™ (coumaphos) all exhibit varying levels of mite resistance, and serious concerns regarding wax and honey contamination are such that use should be limited to a single annual treatment, typically in either early spring or late summer into fall when honey supers are no longer present.

Problems with synthetic miticides has led to the rise in popularity of organic and natural treatments and methods, however, these also have limitations. Of the organic treatments, the two most popular in current use are formic acid, marketed as Miteaway™ treatment strips (fumigation method) as well as oxalic acid, introduced into the hive using the Dribble Method or by vaporization. Formic acid is a powerful organic compound found naturally occurring in honey, but cannot be used in early spring, mid-summer or late fall, as it is temperature sensitive ineffective at lower ambient temperature and lethal to brood and queens at high temperature and is best used in summer months when air temperatures are at least 50° F. but below 84° F. Oxalic acid can be used year-round when vaporized into the hive, but Dribble Methods should only be used once a year, and only when ambient air temperatures are no lower than 50° F. Increased bee mortality has been reported with oxalic acid applied using the Dribble Method, hence many beekeepers have fallen away from this practice. Oxalic acid vaporization method is not capable of killing mites under the broodcap, so any treatments should be done when the hive has no honey supers in spring or late summer into fall, once a week for a period of 2 to 4 weeks to optimally kill mites as they emerge with the brood over the 21-day brood cycle and requires specialized application equipment and an electrical supply (deep cell battery or generator) to vaporize. Natural compounds, such as Hops Acid and thymol, while natural are not necessarily better or safer than synthetics and have been reported to have varying efficacy.

Hence, given the limitations of the prior art, particularly the temperature, brood, and presence or absence of honey supers on the hives, a typical beekeeper's mite management schedule includes an early spring/mid-late fall treatment when the hive is broodless, and temperatures range between 30 to 50° F. with Apivar™ strips, oxalic acid vaporization, or if temperatures are above 50° F. with oxalic acid using the Dribble Method, and then in late spring/early summer/late summer when the hive has brood and honey supers and temperatures range between 50 to 84° F. with Miteaway™ strips (formic acid) or oxalic acid vaporization over a period of weeks. Hence, beekeepers must watch the calendar and keep to a tight schedule to ensure treatments are done timely to avoid problems. An unusual cold snap late in spring, or an early spring or winter with a period of unusual warmth, all complicate the mite management schedule using currently known art.

The treatment presented herein thus eliminates the complicated treatment schedules, allowing beekeepers to treat as necessary, and without worries about contamination, resistance, etc. The strip treatment is easy and quick to use and does not require any expensive equipment. Introduction of the miticide as a solid has the added benefit of controlling dosage placement and amounts, without any extra hazard to the bees, beekeepers, and the environment.

As an added benefit, migratory beekeeping practices, where hives are moved and located according to seasonal nectar flows often force honey bees to feed on a monoculture of pollen, and thus result in essential amino acids deficiencies, which is suspected as a contributing factor in CCD. Thoughtful selection of miticide treatment methods and compounds as described herein during these periods and migratory apicultural practices could provide additional beneficial nutritional supplement to support overall bee health as well as mite control.

Some of the compounds used in the treatment methods described herein exhibit antiviral replication properties which could prove beneficial to reduce expression of viruses the Varroa mites are known to vector into the honey bees during parasitism.

It is to be understood that the above-described arrangements are only illustrative of the application of the principles of the present invention. Numerous modifications and alternative arrangements may be devised by those skilled in the art without departing from the scope of the present invention. It is intended that the invention be construed as including all such alterations and modifications in so far as they come within the scope of the appended claims or the equivalents of these claims.

What is claimed is:

1. A miticide treatment strip for controlling honey bee parasites, comprising:
A treatment strip having a surface;
A base coating of at least one of a thermoplastic wax, resin, and polymer on said surface; and
An acidic compound having an active ingredient applied to said base coating;
Wherein said active ingredient is at least one of an amino acid and a vitamin;
Wherein said acidic compound is a solid; and
Wherein said treatment strip is a substrate further comprised of at least one of plastic, paper, cardboard, mylar, metal, and thermoplastic.

2. The miticide treatment strip in claim 1, wherein said active ingredient is at least one of (S)-2-Amino-5-guanidinopentanoic acid), (2-Amino-3-(1H-imidazol-4-yl)propanoic acid,(2S,3S)-2-amino-3-methylpentanoic acid), 2-Amino-4-methylpentanoic acid, 2,6-Diammoniohexanoic acid, 2-amino-4-(methylthio)butanoic acid, (S)-2-Amino-3-phenylpropanoic acid, (2-Amino-3-hydroxybutanoic acid), (2-Amino-3-(1H-indol-3-yl)propanoic acid, 2-Amino-3-methylbutanoic acid, aminoethanoic acid, 2-Aminopropanoic acid, L-2-Amino-3-(4-hydroxyphenyl)propanoic acid, 2-Amino-3-hydroxypropanoic acid, 2-Amino-3-sulfhydrylpropanoic acid, aminobutanedioic acid, 2-aminopentanedioic acid, 2-amino-3-carbamoylpropanoic acid, 2-amino-4-carbamoylbutanoic acid, pyrrolidine-2-carboxylic acid, pyridine-3-carboxylic acid, (5R)-[(1S)-1,2-Dihydroxyethyl]-3,4-dihydroxyfuran-2(5H)-one, (2S)-2-[[4-[(2-amino-4-oxo-3H-pteridin-6-yl)methylamino]benzoyl]amino]pentanedioic acid, and 5-[(3as,4S,6ar)-2-oxohexahydro-1H-thieno[3,4-d]imidazol-4-yl]pentanoic acid.

3. The miticide treatment strip in claim 1, wherein said active ingredient is 2-aminoglutaric acid.

4. The miticide treatment strip in claim 1, wherein said active ingredient is a crystalline solid.

5. The miticide treatment strip in claim 1, wherein said active ingredient is selected from the group consisting of aminobutanedioic acid, (S)-2-Amino-5-guanidinopentanoic acid), 2-Amino-3-sulfhydrylpropanoic acid, 2-aminopentanedioic acid, (2-Amino-3-(1H-imidazol-4-yl)propanoic acid, and pyrrolidine-2-carboxylic acid.

6. The miticide treatment strip in claim 1, wherein said treatment strip has a thickness of no more than 1.5 mm and is at least one of stock cardboard and corrugated cardboard.

7. The miticide treatment strip in claim 1, wherein said base coating is between 0.2 and 0.4 mm thick.

8. The miticide treatment strip in claim 1, wherein said base coating is at least one of beeswax, paraffin wax, microcrystalline wax, oxidized polyethelene, unoxidized polyethelene and polypropylene.

9. The miticide treatment strip in claim 1, wherein said base coating is at least one of hydrocarbon rosin, modified resin, unmodified resin, and derivatives thereof.

10. The miticide treatment strip in claim 1, wherein said surface holds about 1 g to 5 g of the acidic compound.

11. The miticide treatment strip in claim 1, further comprising adhering said active ingredient to the base coating with an adhesion promoter that is at least one of a film of solvent, tackifying resin, and a plasticizer.

12. The miticide treatment strip in claim 1, wherein said treatment strip is stock cardboard having a thickness of no more than 1.5 mm thick.

13. The miticide treatment strip in claim 1, wherein said treatment strip is corrugated cardboard no more than 2 mm thick.

14. A pest control method for honey bee parasitic mites using a miticide treatment strip within a beehive, wherein the beehive is comprised of a hive body housing at least two frames positioned to have a bee spacing, and a plurality of bees on the frames, the method comprising:
Increasing the bee spacing between the at least two frames;
Hanging the miticide treatment strip vertically between the at least two frames spaced so as to allow the plurality of bees sufficient room to pass over and under all sides of the treatment strip with a passage space between the miticidal strip and the frame measuring less than the bee spacing;
Establishing a first day of a treatment period when the treatment strip is hung between the frames;
Inspecting the treatment strip after 10 to 14 days measured from the first day; and
Removing the treatment strip,
Wherein the miticide treatment strip comprises a substrate coated with a solid acidic compound having as an active ingredient an organic metabolite comprised of at least one of an amino acid and a vitamin,; and
Wherein the plurality of bees further comprises at least one of a quantity of adult bees, a quantity of capped brood, and a quantity of uncapped brood.

15. The method of claim 14, wherein the active ingredient is at least one of (S)-2-Amino-5-guanidinopentanoic acid), (2-Amino-3-(1H-imidazol-4-yl)propanoic acid,(2S,3S)-2-amino-3-methylpentanoic acid), 2-Amino-4-methylpentanoic acid, 2,6-Diaminohexanoic acid, 2-amino-4-(methylthio)butanoic acid, (S)-2-Amino-3-phenylpropanoic acid, (2-Amino-3-hydroxybutanoic acid), (2-Amino-3-(1H-indol-3-yl)propanoic acid, 2-Amino-3-methylbutanoic acid, aminoethanoic acid, 2-Aminopropanoic acid, L-2-Amino-3-(4-hydroxyphenyl)propanoic acid, 2-Amino-3-hydroxypropanoic acid, 2-Amino-3-sulfhydrylpropanoic acid, aminobutanedioic acid, 2-aminopentanedioic acid, 2-amino-3-carbamoylpropanoic acid, 2-amino-4-carbamoylbutanoic acid, pyrrolidine-2-carboxylic acid, pyridine-3-carboxylic acid, (5R)-[(1S)-1,2-Dihydroxyethyl]-3,4-dihydroxyfuran-2(5H)-one, (2S)-2-[[4-[(2-amino-4-oxo-3H-pteridin-6-yl)methylamino]benzoyl]amino]pentanedioic acid, and 5-[(3as,4S,6ar)-2-oxohexahydro-1H-thieno[3,4-d]imidazol-4-yl]pentanoic acid.

16. The method of claim 14, wherein the active ingredient is selected from the group consisting of aminobutanedioic acid, (S)-2-Amino-5-guanidinopentanoic acid), 2-Amino-3-sulfhydrylpropanoic acid, 2-aminopentanedioic acid, (2-Amino-3-(1H-imidazol-4-yl)propanoic acid, and pyrrolidine-2-carboxylic acid.

17. The method of claim 14, prior to the step of hanging, further comprising the steps of:
Determining whether the quantity of uncapped brood is present in at least one frame; and
Positioning the treatment strip immediately adjacent the uncapped brood.

18. The method of claim 14, after the step of removing, further comprising the steps of:
Assessing whether capped brood is present in the hive;
Replacing the treatment strip with a fresh treatment strip; and
Removing the fresh treatment strip no earlier than 21 days after the first day of the treatment period; and
Repeating the steps of assessing, replacing with a fresh strip, and removing the fresh strip until there are less than 2 mites per 100 bees present in the hive.

19. The method of claim 14, wherein one treatment strip is used per four to five frames of uncapped brood.

20. A miticide solution for controlling honey bee parasites, comprising:
An aqueous-sucrose solution in a 1:1 ratio into which a predetermined quantity of an acidic compound having an active ingredient is mixed such that a concentration of active ingredient in the miticide solution is about 3.5 to 5.5%;
Wherein the active ingredient is at least one of (S)-2-Amino-5-guanidinopentanoic acid), (2-Amino-3-(1H-imidazol-4-yl) propanoic acid,(2S,3S)-2-amino-3-methylpentanoic acid), 2-Amino-4-methylpentanoic acid, 2,6-Diaminohexanoic acid, 2-amino-4-(methylthio) butanoic acid, (S)-2-Amino-3-phenylpropanoic acid, (2-Amino-3-hydroxybutanoic acid), (2-Amino-3-(1H-indol-3-yl) propanoic acid, 2-Amino-3-methylbutanoic acid, aminoethanoic acid, 2-Aminopropanoic acid, L-2-Amino-3-(4-hydroxyphenyl) propanoic acid, 2-Amino-3-hydroxypropanoic acid, 2-Amino-3-sulfhydrylpropanoic acid, aminobutanedioic acid, 2-aminopentanedioic acid, 2-amino-3-carbamoylpropanoic acid, 2-amino-4-carbamoylbutanoic acid, pyrrolidine-2-carboxylic acid, pyridine-3-carboxylic acid, (5R)-[(1S)-1,2-Dihydroxyethyl]-3,4-dihydroxyfuran-2(5H)-one, (2S)-2-[[4-[(2-amino-4-oxo-3H-pteridin-6-yl)methylamino]benzoyl]amino]pentanedioic acid, and 5-[(3as,4S,6ar)-2-oxohexahydro-1H-thieno[3,4-d]imidazol-4-yl]pentanoic acid.
